(19) United States
(12) Patent Application Publication
(10) Pub. No.: US 2025/0015412 A1
(43) Pub. Date: Jan. 9, 2025

(54) CONTROLLING INTERNAL BATTERY PRESSURE BUILDUP IN RECHARGABLE BATTERIES WITH A CRUSHABLE INSERT LAYER

(71) Applicant: GM GLOBAL TECHNOLOGY OPERATIONS LLC, Detroit, MI (US)

(72) Inventors: Meng Jiang, Rochester Hills, MI (US); Yongjie Zhu, Troy, MI (US); Louis G. Hector, JR., Shelby Township, MI (US); Meinan He, Birmingham, MI (US); Srikanth Arisetty, Novi, MI (US); Mei Cai, Bloomfiled Hills, MI (US)

(73) Assignee: GM GLOBAL TECHNOLOGY OPERATIONS LLC, Detroit, MI (US)

(21) Appl. No.: 18/347,091

(22) Filed: Jul. 5, 2023

(51) Int. Cl. H01M 50/242; B60L 50/64; H01M 10/0525; H01M 50/209; H01M 50/231; H01M 50/249

(52) U.S. Cl. CPC H01M 50/242; B60L 50/64; H01M 10/0525; H01M 50/209; H01M 50/231; H01M 50/249; H01M 2220/20

(57) ABSTRACT

Excessive expansion of rechargeable batteries during recharging is a significant concern since the uncontrolled buildup of high internal battery pressures from expansion inside a confined space can lead to separator membrane failure and/or thermal runaway of a battery cell. A crushable foam or honeycomb insert layer is placed inside of a rigid battery fixture to automatically limit the progressive buildup of internal battery pressure due to charging-induced expansion of the battery cell during recharging. The crushable insert layer is included as part of the rigid battery fixture. Aluminum honeycomb cores and porous aluminum metal foam materials have a significant amount of crushability over a very wide range of compressive strains. Alternatively, a porous metal foam or metal honeycomb material may be infused with a liquid polymer (e.g., silicone, rubber, EDPM, or polyurethane) to enhance the mechanical properties of the polymer-infused metal foam or honeycomb metal/polymer composite material.

### INTRODUCTION

This disclosure relates to rechargeable batteries (e.g., lithium-ion or lithium-metal batteries) for use in electric vehicles or other electric-powered devices. A crushable insert layer is used to limit the buildup of internal pressure within a battery during recharging.

FIG. 1 shows a schematic plot of an example of Internal Battery Pressure (MPa) versus Number of Battery Charging Cycles, for a Lithium-ion battery that is confined in a rigid battery fixture. An initial, minimal amount of internal (compressive) battery pressure is beneficial when a Lithium-ion battery is charged or recharged. This initial, compressive internal battery pressure can range from 14-120 psi (0.1-0.8 MPa). However, each time the battery cell is recharged, the cell expands (i.e., swells) a small amount, which causes a net increase in the average internal battery pressure when the battery cell is confined in a rigid battery fixture (i.e., case, can, housing, or between a pair of bolted, rigid plates). The net increase of average internal battery pressure occurs due to irreversible electrochemical processes inside of the battery cell. Because of this, the average internal battery pressure continues to increase, without limit, as the number of recharging cycles increases. Compressive internal battery pressures can reach as high as 1.6 MPa (240 psi) after multiple re-charging cycles, as shown schematically in FIG. 1. When the battery's internal battery pressure exceeds a critical threshold, the battery can be damaged. Such damage can include breakage of internal components, electrodes, and electrical connections; as well as growth of internal dendrites across the separator membrane that can lead to electrical short circuiting and subsequent Thermal Runaway (TR).

What is needed, therefore, is a mechanical design that automatically limits and controls the buildup of internal battery pressure to an acceptable level by using a crushable insert layer disposed inside of the battery cell's external fixture.

### SUMMARY

Excessive expansion of rechargeable batteries during recharging is a significant concern, since the uncontrolled buildup of high internal battery pressures from expansion in a confined space (e.g., a rigid battery fixture) may lead to separator membrane failure and/or thermal runaway initiating in a battery cell. In some embodiments, a crushable foam or honeycomb insert layer is placed inside of a battery fixture to automatically limit the progressive buildup of internal battery pressure due to charging-induced expansion of the battery cell when the cell is confined in a rigid battery fixture. The crushable insert layer is included as part of the battery fixture. A metal material with a honeycomb or a porous metal foam structure has a significant amount of crushability over a very wide range of compressive strains.

In some embodiments, a battery module includes: a rigid battery fixture; a battery cell confined in the rigid battery fixture; and a crushable insert layer, having a crushing strength, and located inside of the rigid battery fixture adjacent to the battery cell. The crushable insert layer and the rigid battery fixture are cooperatively configured to limit internal battery pressure buildup inside of the battery cell during recharging cycles to be less than or equal to the crushing strength of the crushable insert layer.

In some embodiments, the crushable insert layer is a metal honeycomb material.

In some embodiments, the metal honeycomb material is an aluminum metal honeycomb material.

In some embodiments, the crushable insert layer is a porous metal foam material.

In some embodiments, the porous metal foam material is an aluminum porous metal foam material.

In some embodiments, the crushable insert layer has a crushing strength ranging from 1 to 1.5 MPa.

In some embodiments, the crushable insert layer is infused with a polymer material to make a polymer-infused crushable insert layer.

In some embodiments, the polymer-infused crushable insert layer has a surface, and the battery module further includes an additional layer including a polymer material that is disposed on the surface of the polymer-infused crushable insert layer.

In some embodiments, the polymer for the polymer-infused crushable insert layer is chosen from silicone, silicone foam, polyurethane, polyurethane foam, EDPM, EDPM foam, rubber, or rubber foam, or combinations thereof.

In some embodiments, the battery module is a Lithium-ion or Lithium-Metal battery module.

In some embodiments, the battery module further includes a polymeric interlayer disposed adjacent to the crushable insert layer and inside of the rigid battery fixture.

In some embodiments, an electric motor vehicle includes: a vehicle body with a passenger compartment; a plurality of road wheels attached to the vehicle body; one or more traction motors attached to the vehicle body that are operable to drive one or more of the plurality of road wheels to thereby propel the electric motor vehicle; and a traction battery pack attached to the vehicle body and electrically connected to the one or more traction motors. The traction battery pack comprises a plurality of prismatic battery modules arranged in mutually parallel rows; and each prismatic battery module comprises: a rigid battery fixture; a battery cell confined in the rigid battery fixture; and a crushable insert layer, having a crushable strength, that is located inside of the rigid battery fixture adjacent to the battery cell. The crushable insert layer and the rigid battery fixture are cooperatively configured to limit internal battery pressure buildup inside of the battery cell during recharging cycles to be less than or equal to the crushing strength of the crushable insert layer.

In some embodiments, a method of making a battery module includes: providing a battery cell; providing a rigid battery fixture; confining the battery cell in the rigid battery fixture; and placing a crushable insert layer, having a crushing strength, inside of the rigid battery fixture adjacent to the battery cell. The crushable insert layer and the rigid battery fixture are cooperatively configured to limit internal battery pressure buildup inside of the battery cell during recharging cycles to be less than or equal to the crushing strength of the crushable insert layer.

In some embodiments, the battery cell is a Lithium-ion or a Lithium-Metal battery cell; and the crushable insert layer is an aluminum honeycomb material or an aluminum porous metal foam material.

### BRIEF DESCRIPTION OF THE DRAWINGS

FIG. 1 shows a schematic plot of an example of Internal Battery Pressure versus Number of Battery Re-Charging Cycles, for a Lithium-ion battery cell that is housed in a rigid battery fixture without a crushable insert, according to the present disclosure.

FIG. 2 shows a schematic plot of an example of Internal Battery Pressure versus Number of Battery Recharging Cycles, for a Lithium-ion battery cell that is housed in a rigid battery fixture with a crushable insert layer, according to the present disclosure.

FIG. 3A shows a schematic, cross-sectional view through an example of a rechargeable battery cell with a pressure-limiting, crushable insert layer that is clamped in-between a pair of rigid plates, before being recharged, according to the present disclosure.

FIG. 3B shows a schematic, cross-sectional view through an example of a rechargeable battery cell with a pressure-limiting, crushable insert layer that is clamped in-between a pair of rigid fixture plates, after undergoing multiple recharging cycles, according to the present disclosure.

FIG. 4 shows perspective views of examples of different crushable aluminum honeycomb and aluminum metal foam materials, according to the present disclosure.

FIG. 5 shows a schematic, compressive stress vs strain plot of an example of a generic crushable metal honeycomb core material undergoing permanent compression (i.e., crushing) and subsequent densification, according to the present disclosure.

FIG. 6 shows a schematic, compressive stress vs strain plot of an example of a generic crushable porous metal foam material undergoing permanent compression (i.e., crushing) and subsequent densification, according to the present disclosure.

FIG. 7A shows a schematic, cross-sectional view of an example of a crushable Metal Foam material Infused with a Polymer material (MFIP), according to the present disclosure.

FIG. 7B shows a schematic, cross-section view of an example of a crushable, Metallic Honeycomb material Infused with a Polymeric material (MHIP), according to the present disclosure.

FIG. 8 shows a schematic, perspective view of an example of an electric vehicle with a rechargeable battery pack and traction motor, according to the present disclosure.

### DETAILED DESCRIPTION

Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

The words “crushable” and “crushability” refer to the permanent deformation of a porous or honeycomb crushable material during compressive loading, which results in a net permanent deformation (i.e., “permanent set”) after the compressive loading has been removed. The words “expansion” and “swelling” are used interchangeably, which occurs during battery recharging. The words “layer” and “insert” are used interchangeably, as they refer to a crushable insert layer. The words “buildup” and “rise” are used interchangeably, as they refer to an increase in the internal battery pressure when the battery is being recharged. The terms “honeycomb core” and “honeycomb matrix” are used interchangeably.

In some embodiments, the battery case or battery can that contains the rechargable battery cell(s) may have a cylindrical or prismatic (e.g., rectangular) shape.

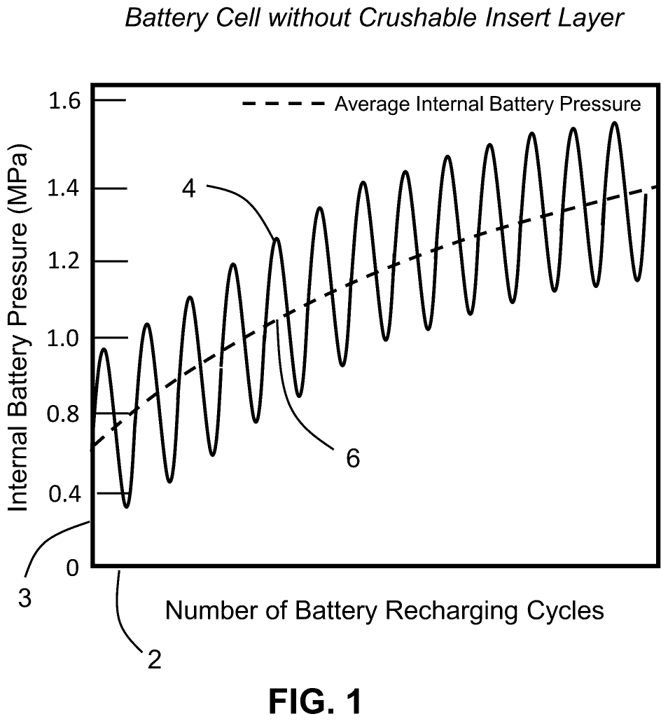

FIG. 1 shows a schematic plot of an example of Internal Battery Pressure (MPa) on the vertical axis 3 versus Number of Battery Recharging Cycles on the horizontal axis 2, for a rechargeable battery cell that is housed in a rigid battery fixture (not shown). A small amount of internal (compressive) battery pressure 4 is beneficial when a rechargeable battery is charged or recharged. This initial, compressive internal battery pressure 4 may range from, for example, 14-120 psi (0.1-0.8 MPa). However, each time the rechargeable battery cell is recharged, the battery cell expands (i.e., swells) a small amount, which causes the internal battery pressure to progressively increase during recharging when the battery cell is confined inside a rigid battery fixture (e.g., a pair of rigid plates held rigidly by bolts). A net increase of the average internal battery pressure 6 occurs due to irreversible electrochemical processes inside of the battery cell. Because of this, the average internal battery pressure 6 continues to increase, without limit, as the number of re-charging cycles increases. Internal cell pressures can reach as high as, for example, 1.6 MPa (240 psi) after multiple recharging cycles. When the internal battery pressure 4 exceeds a critical threshold, the battery can be damaged. Such damage can include breakage of internal components, electrodes, and electrical connections; as well as growth of internal metal dendrites across the separator membrane that can lead to short circuiting across the separator membrane and Thermal Runaway (TR).

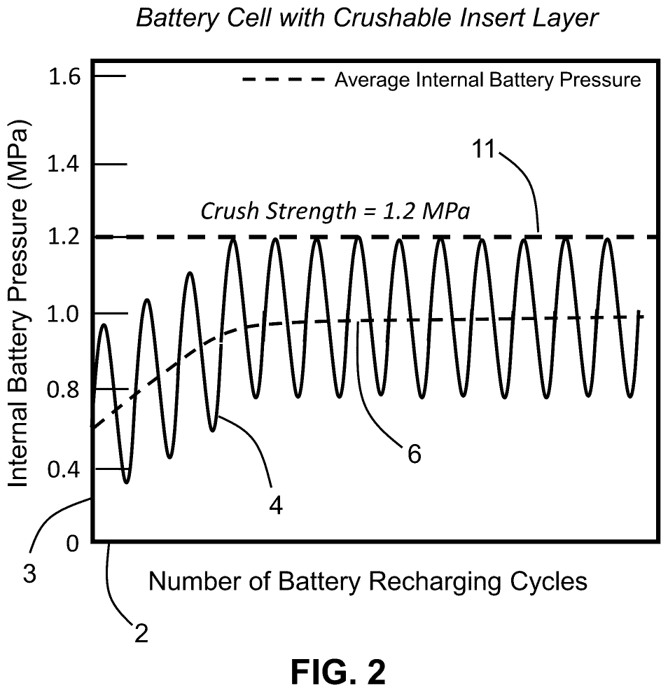

FIG. 2 shows a schematic plot of an example of Internal Battery Pressure on the vertical axis 3 with a crushable insert versus Number of Battery Recharging Cycles on the horizontal axis 2, for a rechargeable battery cell that is housed in a rigid battery fixture with a crushable insert layer disposed inside the battery fixture, according to the present disclosure. In this example, the crushing strength limit 11 equals, for example, 1.2 MPa, which automatically limits the buildup of internal battery pressure 4 during battery recharging to be less than or equal to the crushing strength limit of 1.2 MPa. The average Internal Battery Pressure 6 is also limited by using a crushable insert layer. The expansion of the battery cell due to charging-induced swelling is accommodated (i.e., buffered) by the simultaneous crushing of the crushable insert layer. Note: the crushing is a progressive process, since deformation is permanent and, hence, is not recoverable.

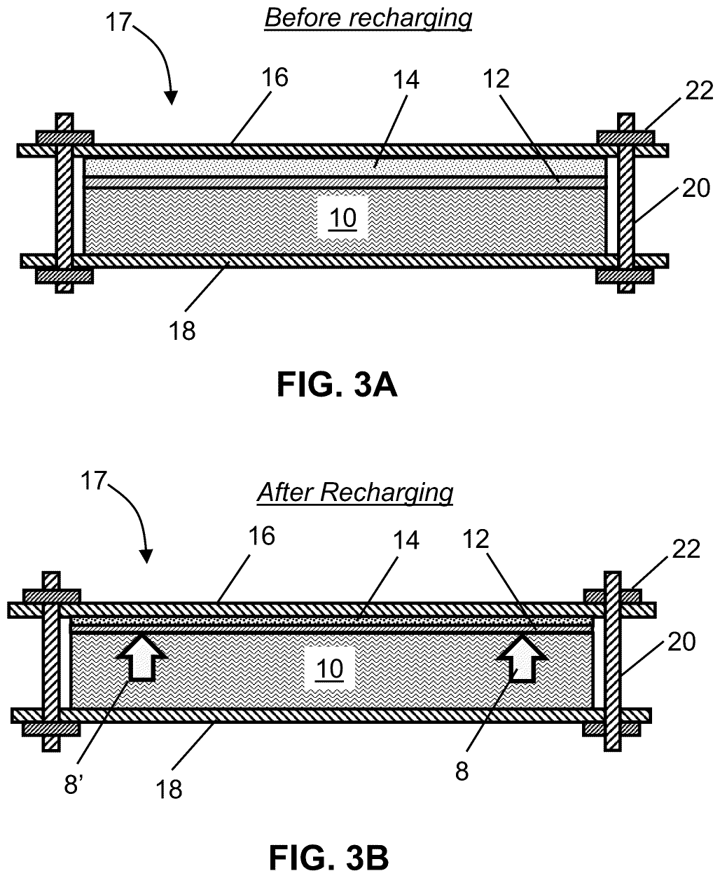

FIG. 3A shows a schematic, cross-sectional view through an example of a rechargeable battery cell 10 with a pressure-limiting crushable insert layer 14 that is clamped in-between a rigid battery fixture comprising two rigid plates 16 and 18, before being recharged, according to the present disclosure. In this embodiment, rechargeable battery cell 10 has a prismatic shape (e.g., rectangular) and it is confined in a rigid battery fixture 17 by a pair of parallel, rigid plates 16 and 18 that are rigidly held by a pair of bolt(s) 20 and nut(s) 22. Optionally, the rigid battery fixture 17 can be replaced with a welded and/or extruded rigid battery case or battery can (not shown). Optionally, a polymeric interlayer 12 may be disposed inside of rigid battery fixture 17, adjacent to battery cell 10 or adjacent to crushable insert layer 14. Polymeric interlayer 12 may be made of a silicone, silicone foam, polyurethane, polyurethane foam, EDPM, EDPM foam, rubber, or rubber foam material, or combinations thereof, which helps to provide a uniform compressive pressure across the surface of battery cell 10. Permanent deformation of the polymeric interlayer 12 may occur at a relatively-low compressive stress of, for example, 40 psi (0.3 MPa) for silicone foam. Both the crushable insert layer 14 and the optional polymeric interlayer 12 may be placed on the upper side of battery cell 10; on the lower side of battery cell 10, and/or on both sides of battery cell 10. The crushable insert layer 14, optional polymeric interlayer 12, and the rigid battery fixture 17 are cooperatively configured to limit internal battery pressure buildup inside of the battery cell during recharging cycles to be less than or equal to the crushing strength of the crushable insert layer 14. The thickness of crushable insert layer 14 may range from 0.5 mm to 30 mm; and it may be as thick as several centimeters (e.g., for a large battery pack). The crushable insert layer 14 may also function as a thermal conductor to conduct heat away from battery cell 10.

FIG. 3B shows a schematic, cross-sectional view through an example of a rechargeable battery cell 10 with a pressure-limiting, crushable insert layer 14 that is clamped in-between two rigid plates 16 and 18, after undergoing multiple recharging cycles, according to the present disclosure. In this embodiment, rechargeable battery cell 10 has a prismatic shape (e.g., rectangular) and it is confined in a rigid battery fixture 17 by a pair of parallel, rigid plates 16 and 18 that are rigidly held by a pair of bolt(s) 20 and nut(s) 22. Battery cell 10 has swollen and expanded upward due to recharging swelling (see upward-pointing arrows 8 and 8′). This electrochemical expansion of battery cell 10 is automatically accommodated by simultaneous compression of the crushable insert layer 14. Note: in FIG. 3B, insert 14 has been compressed (as compared to the initial thicker layer shown in FIG. 3A). Optional polymeric interlayer 12 is also partially compressed in FIG. 3B due to the expansion of battery cell 10 during recharging cycles.

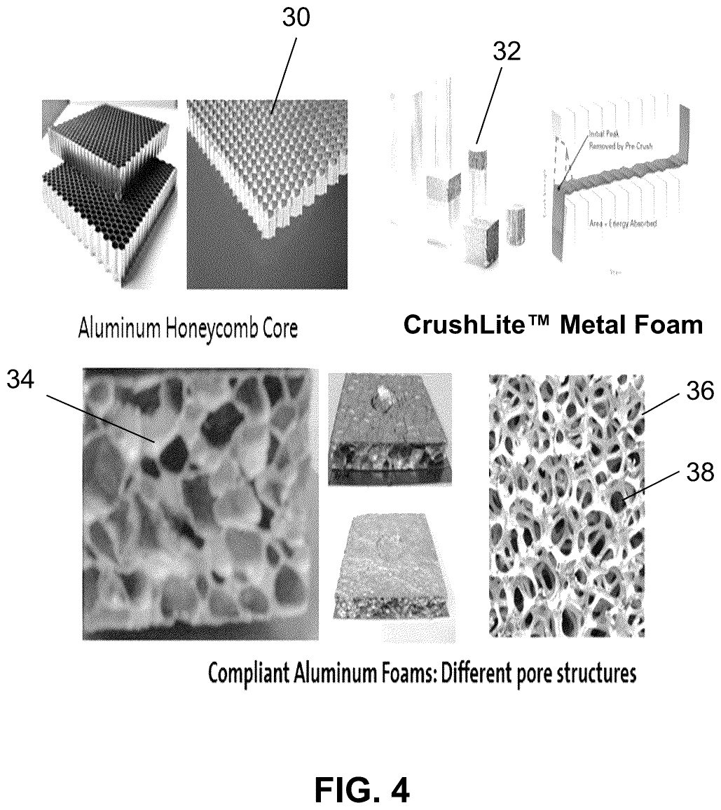

FIG. 4 shows various examples of different crushable aluminum honeycomb and aluminum foam materials, according to the present disclosure. Pressure-limiting, crushable insert layer 14 may comprise a metallic foam material 32 and 34, or a metallic honeycomb material 30. In some embodiments, the materials used for crushable insert layer 14 may be chosen from, for example, aluminum, aluminum alloy, steel, nickel, copper, copper alloy, or polymer, or combinations thereof. FIG. 4 shows examples of different porous aluminum structures, including: (a) an aluminum honeycomb core material 30; (b) a “CrushLite™” aluminum foil-based honeycomb material 32; and a porous aluminum foam material 34 (which comprises a plurality of aluminum web ligaments 36 and hollow pores 38). The CrushLite™ aluminum foil honeycomb material 32 has a crushing strength ranging from 8 to 750 psi (0.05 to 5 MPa), depending on the specific design (e.g., alloy composition, yield strength, pore size, cell geometry, and/or wall thickness, etc.).

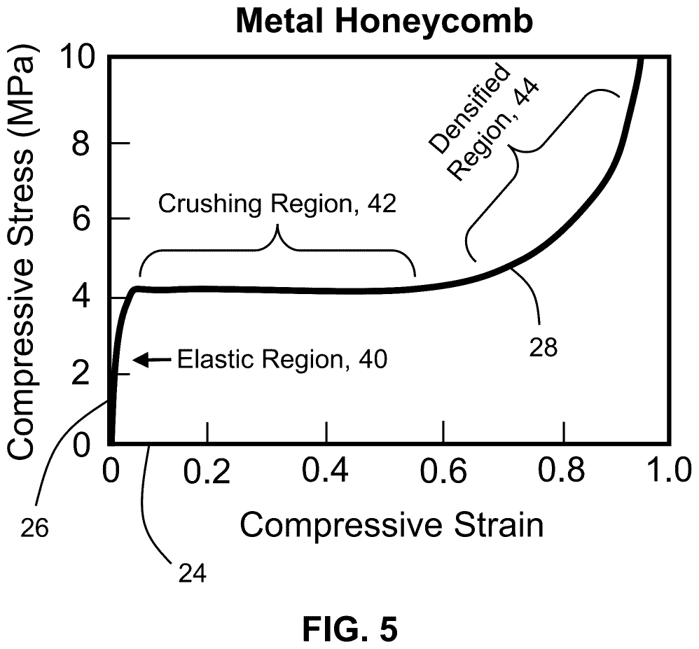

FIG. 5 shows a schematic, stress vs. strain curve of an example of a generic crushable metal honeycomb core material undergoing permanent compression (i.e., crushing) and subsequent densification, according to the present disclosure. This stress-strain curve 28 shows compressive strain on the X-axis 24, and compressive stress on the Y-axis 26. This plot illustrates a number of different regions for the overall stress-strain curve 28, including (a) an elastic region 40 at low strains (e.g., less than about 0.05 strain); (b) a crushing region 42 where the honeycomb material is being crushed (i.e., buckling), which limits the stress to be no more than the crushing strength limit (e.g., 4 MPa). This is then followed by (c) a densified region 44 where the honeycomb ultimately becomes fully crushed and densified, which displays a rapid increase in stress for a small amount of additional strain in the densified region 44.

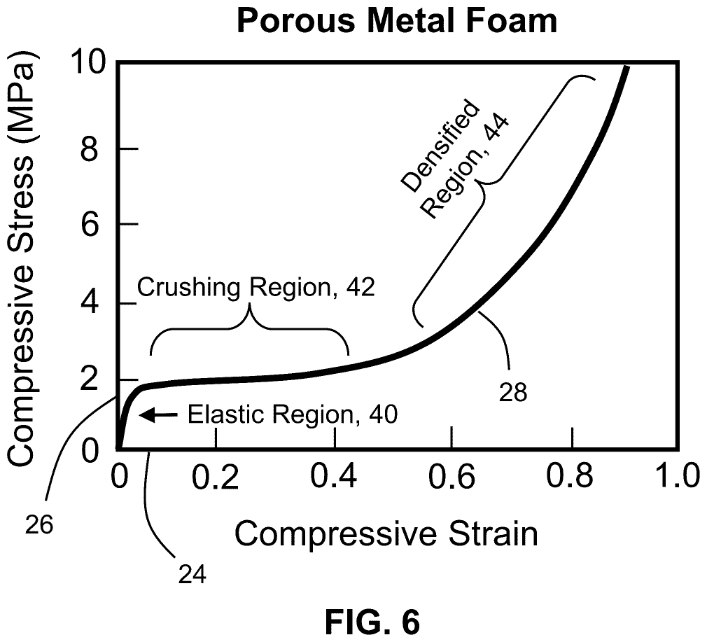

FIG. 6 shows a schematic, stress vs. strain curve 28 of an example of a generic, crushable, porous metal foam material undergoing permanent compression and subsequent densification, according to the present disclosure. This stress-strain curve 28 shows compressive strain on the X-axis 24, and the compressive stress on the Y-axis 26. The plot illustrates a number of regions for the stress-strain curve 28, including (a) an elastic zone 40 at low strains (e.g., less than about 0.05 strain); (b) a crushing region 42 where the porous foam material is being crushed (which limits the stress to be no more than the crushing strength limit (e.g., 2-3 MPa)); followed by (c) a densified region 44 where the porous metal foam material ultimately becomes fully crushed and densified, which shows a rapid increase in stress for a small amount of additional strain in the densified region 44.

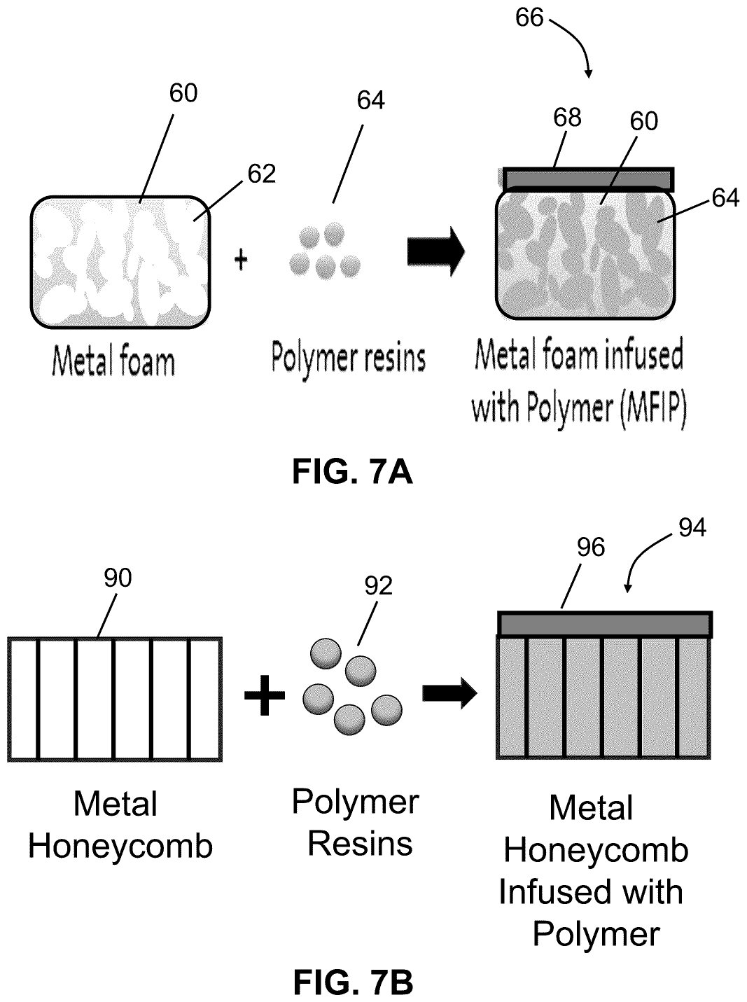

FIG. 7A shows a schematic cross-section view of an example of a crushable, porous metal foam material infused with a polymeric material, according to the present disclosure. In this embodiment, the crushable, polymer-infused foam material 66 comprises a crushable, porous metal foam matrix 60 (e.g., porous scaffold) with a plurality of pores 62 distributed throughout the porous metal foam matrix 60. The porous metal matrix 60 is infused with a liquid polymer resins 64 to make a Metal Foam Infused Polymer (MFIP) composite material 66 that comprises a crushable, metal foam matrix 60 with polymer-filled pores 64.

Referring still to FIG. 7A, an optional cover layer 68 made of a same or similar polymeric material may be deposited or disposed on one (or more) surface(s) of MFIP material 66. Polymeric cover layer 68 may help ensure that homogeneous pressure is applied uniformly across the entire surface of battery cell 10. The polymeric cover layer 68 may be the same polymeric material that is used to infuse the porous metal foam matrix 60 to make a MFIP material 66.

FIG. 7B shows a schematic, cross-section view of an example of a crushable, Metallic Honeycomb material 90 Infused with a Polymeric material 92 (MHIP 94), according to the present disclosure. The metallic honeycomb core material 90 is infused with liquid polymer resins 92 to make a Metal Honeycomb Infused Polymer (MHIP) composite material 94. An optional cover layer 96 made of a same or similar polymeric material may be deposited or disposed on one (or more) surface(s) of MHIP material 94. Polymeric cover layer 96 may help ensure that homogeneous pressure is applied uniformly across the entire surface of battery cell 10. The optional polymeric cover layer 96 may be the same polymeric material that is used to infuse the metal honeycomb matrix 90 to make a MHIP material 94.

Referring to FIGS. 7A and 7B, the mechanical properties (e.g., stress-strain curve, crushing strength, etc.) of a MFIP material 66 or MHIP material 94 may be enhanced depending on the amount and type of polymer material that infused into the porous foam or honeycomb matrix. Silicone, polyurethane, EDPM, or rubber, or combinations thereof, may be used as the polymer material that is infused into the MFIP material 66 or MHIP material 94.

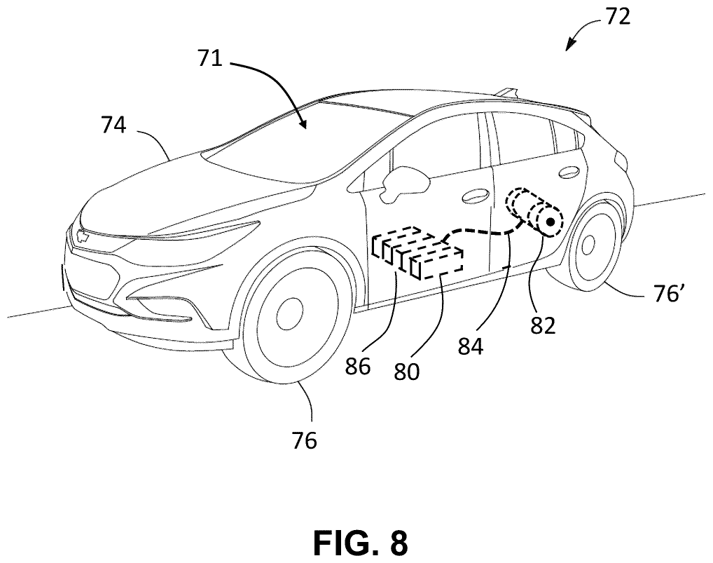

FIG. 8 shows a schematic perspective view of an example of an electric vehicle 72 with a rechargeable battery pack 80, according to the present disclosure. Electric vehicle 72 includes a vehicle body 74, a passenger compartment 71 disposed inside of vehicle body 74, a plurality of road wheels 76, 76′, etc. attached to vehicle body 74, and a rechargeable battery pack 80 located inside of electric motor vehicle 72. Electric motor vehicle 72 further comprises one or more electric traction motors 82 attached to vehicle body 74 that are operable to drive one or more of the road wheels 76, 76′, etc. that propels electric motor vehicle 72. Rechargeable battery pack 80 is attached to vehicle body 74. Battery pack 80 is electrically connected to the electric traction motor(s) 82 via power cable 84. The battery pack 80 comprises a plurality of prismatic battery modules 86 arranged in mutually parallel rows.

In some embodiments, the crushable insert layer 14 shown in FIGS. 3A and 3B may also be used at a battery module/pack level.

While the best modes for carrying out the disclosure have been described in detail, those familiar with the art to which this disclosure relates will recognize various alternative designs and embodiments for practicing the disclosure within the scope of the appended claims.

1. A battery module, comprising:
a rigid battery fixture;
a battery cell confined in the rigid battery fixture; and
a crushable insert layer, having a crushing strength, that is disposed inside of the rigid battery fixture adjacent to the battery cell;
wherein the crushable insert layer and the rigid battery fixture are cooperatively configured to limit internal battery pressure buildup inside of the battery cell during recharging cycles to be less than or equal to the crushing strength of the crushable insert layer.

2. The battery module of claim 1, wherein the crushable insert layer comprises a metal honeycomb material.

3. The battery module of claim 2, wherein the metal honeycomb material comprises an aluminum metal honeycomb material.

4. The battery module of claim 1, wherein the crushable insert layer comprises a porous metal foam material.

5. The battery module of claim 4, wherein the porous metal foam material comprises a porous aluminum foam material.

6. The battery module of claim 1, wherein the crushable insert layer has a crushing strength ranging from 1 to 1.5 MPa.

7. The battery module of claim 1, wherein the crushable insert layer is infused with a polymeric material to make a polymer-infused crushable insert layer.

8. The battery module of claim 7,
wherein the polymer-infused crushable insert layer has a surface; and
wherein the battery module further comprises an additional layer comprising a polymeric material that is disposed on the surface of the polymer-infused crushable insert layer.

9. The battery module of claim 7, wherein the polymeric material is chosen from silicone, silicone foam, polyurethane, polyurethane foam, EDPM, EDPM foam, rubber, rubber foam, or combinations thereof.

10. The battery module of claim 1, wherein the battery module comprises a Lithium-ion or Lithium-Metal battery module.

11. The battery module of claim 1, further comprising a polymeric interlayer disposed adjacent to the crushable insert layer, inside of the rigid battery fixture.

12. An electric motor vehicle, comprising:
a vehicle body with a passenger compartment;
a plurality of road wheels attached to the vehicle body;
one or more traction motors attached to the vehicle body that are operable to drive one or more of the plurality of road wheels to thereby propel the electric motor vehicle; and
a traction battery pack attached to the vehicle body and electrically connected to the one or more traction motors;
wherein the traction battery pack comprises a plurality of prismatic battery modules arranged in mutually parallel rows; and
wherein each prismatic battery module comprises:
a rigid battery fixture;
a battery cell confined in a rigid battery fixture; and
a crushable insert layer, having a crushing strength, that is disposed inside of the rigid battery fixture adjacent to the battery cell;
wherein the crushable insert layer and the rigid battery fixture are cooperatively configured to limit internal battery pressure buildup inside of the battery cell during recharging cycles to be less than or equal to the crushing strength of the crushable insert layer.

13. The electric motor vehicle of claim 12, wherein the crushable insert layer comprises an aluminum metal honeycomb material.

14. The electric motor vehicle of claim 12, wherein the crushable insert layer comprises a porous aluminum metal foam material.

15. The electric motor vehicle of claim 12, wherein the crushable insert layer has a crushing strength ranging from 1 to 1.5 MPa.

16. The electric motor vehicle of claim 12, wherein the crushable insert layer is infused with a polymeric material.

17. The electric motor vehicle of claim 16, wherein the polymeric material is chosen from silicone, silicone foam, polyurethane, polyurethane foam, EDPM, EDPM foam, rubber, or rubber foam, of combinations thereof.

18. The electric motor vehicle of claim 12, wherein the battery cell comprises a Lithium-ion or a Lithium-Metal battery cell.

19. A method for making a battery module, the method comprising:
providing a battery cell;
providing a rigid battery fixture;
confining the battery cell in the rigid battery fixture; and
disposing a crushable insert layer, having a crushing strength, inside of the rigid battery fixture adjacent to the battery cell;
wherein the crushable insert layer and the rigid battery fixture are cooperatively configured to limit internal battery pressure buildup inside of the battery cell during recharging cycles to be less than or equal to the crushing strength of the crushable insert layer.

20. The method of claim 19,
wherein the battery cell comprises a Lithium-ion or a Lithium-Metal battery cell; and
wherein the crushable insert layer comprises an aluminum honeycomb material or a porous aluminum metal foam material.
